(19) United States
(12) Patent Application Publication
(10) Pub. No.: US 2025/0250054 A1
(43) Pub. Date: Aug. 7, 2025

(54) Machine for forming filters for infusion capsules and relative cleaning method

(71) Applicant: G.D S.p.A, Bologna (BO) (IT)

(72) Inventors: Andrea BIONDI, Bologna (BO) (IT); Antonio VITALI, Bologna (BO) (IT); Umberto ZANETTI, Bologna (BO) (IT); Lorenzo FILOSA, Bologna (BO) (IT); Salvatore CARBONI, Bologna (BO) (IT)

(21) Appl. No.: 19/044,986

(22) Filed: Feb. 4, 2025

(30) Foreign Application Priority Data
Feb. 5, 2024 (IT) 102024000002364

(51) Int. Cl. B65B 59/00; A46B 9/02; A46B 13/00; A46B 13/02

(52) U.S. Cl. CPC B65B 59/00; A46B 9/026; A46B 13/001; A46B 13/02; A46B 2200/3073; B65B 2210/06

(57) ABSTRACT

A machine for forming filters for infusion capsules, and relative cleaning method, the machine including one or more forming devices, one or more cleaning devices, each cleaning device having one or more cleaning elements; a first movement system configured to move the one or more cleaning elements between a disengagement position, wherein the cleaning elements do not mechanically interact with the forming devices, and a cleaning position, where the one or more cleaning elements mechanically interact with at least one forming device; and a second movement system configured to impart to the one or more cleaning elements, when in the cleaning position, a reciprocating linear motion along the forming axis to rub the one or more cleaning elements on at least a part of the forming surface of the forming device.

### TECHNICAL FIELD OF THE INVENTION

The present invention relates to a machine for forming filters for infusion capsules and to a related method for cleaning. The present invention finds a preferred application in the sector of production of capsules for infusion products, in particular beverages that are obtained with an infusion process and with the addition of an edible liquid such as water or milk, to obtain an infusion, for example coffee.

### STATE OF THE ART

WO2022029548A describes a device and a method for producing infusion capsules, comprising a transport device of the carousel type on which are mounted a plurality of forming devices, each of which provides the forming of the filter for infusion products starting from flat discs of a filtering material. Each forming device comprises a through cavity and a punch, both provided with ribs that cooperate with each other to perform the pleating on the lateral wall of the filter. The interference between the respective ribs, together with heat, determines an effect of ironing of the filtering material that constitutes the disc, which causes a permanent deformation.

### ABSTRACT OF THE INVENTION

The terms “upstream” and “downstream” refer to the direction of the production flow. The Applicant has observed that in the field of production of infusion capsules, the devices dedicated to the forming of filters are subject to soiling deriving for example from the release of material from the sheet-like element subjected to forming, such material progressively depositing on the forming surfaces of the forming devices. Indeed, the sheet-like elements are typically made of a composite material comprising among other things paper and polymeric material. The friction and/or the heat to which such composite material is subjected during the forming favour the undesired deposit of material on the forming surfaces.

The Applicant has also realized that the cleaning of such forming devices, when performed manually (at a fixed frequency or varying according to the actual soiling conditions), requires a long time, resulting in a high overall machine downtime and/or labour employment, as well as achieving a level of cleaning that is not always adequate.

The Applicant has addressed the problem of cleaning the forming devices of the filters for the production of infusion capsules, in particular the forming surfaces of such devices, in an effective, rapid, and/or economical manner, limiting the overall machine downtime and/or labour employment and/or related costs.

According to the Applicant, the aforementioned problem is solved by a machine and a related method in accordance with the appended claims and/or according to the following aspects and embodiments.

In one aspect the invention relates to a machine for forming filters for infusion capsules, the machine comprising one or more forming devices, each forming device comprising a forming surface for the forming of said filters.

Preferably the forming surface has a substantially cylindrical configuration developing around a forming axis.

Preferably the machine comprises one or more cleaning devices.

Preferably each cleaning device comprises one or more cleaning elements.

Preferably each cleaning device comprises a first movement system configured to move said one or more cleaning elements between a disengagement position, wherein said one or more cleaning elements do not mechanically interact with said one or more forming devices, and a cleaning position, wherein said one or more cleaning elements mechanically interact with at least one forming device of said one or more forming devices.

Preferably each cleaning device comprises a second movement system configured to impart to said one or more cleaning elements, when in said cleaning position, a reciprocating linear motion along said forming axis to rub said one or more cleaning elements on at least a part of said forming surface of said at least one forming device. In one aspect the invention relates to a cleaning method of a machine according to the preceding aspect and in any one of the embodiments.

Preferably the method comprises moving said one or more cleaning elements of at least one of said one or more cleaning devices from said disengagement position to said cleaning position.

Preferably the method comprises imparting to said one or more cleaning elements, in said cleaning position, said reciprocating linear motion to rub said one or more cleaning elements on at least a part of said forming surface of said at least one forming device. In one aspect the invention relates to a system for the production of infusion capsules comprising the machine for forming filters according to the aforementioned aspect and in any one of the embodiments.

According to the Applicant the movement of the one or more cleaning elements between the disengagement position and the cleaning position and their movement, in the cleaning position, of reciprocating linear motion along the forming axis while rubbing the forming surface allows on one hand not to interfere with the normal functioning of the machine, when in the disengagement position, and on the other hand, when cleaning is necessary, an effective and/or rapid cleaning of the configuration surface, when in the cleaning position, all without recourse to labour or supervision by an operator.

The invention may have one or more of the following preferred features.

Preferably each forming device comprises a forming body comprising a through cavity internally defining a first portion of said forming surface, said first portion more preferably having a cylindrical development around said forming axis.

Preferably each forming device comprises a punch externally defining a second portion of said forming surface. Preferably said punch is configured to slidingly engage said through cavity, being movable along said forming axis between an upper end, outside of, and above, said cavity, and a lower end near a lower mouth of said cavity. The cylindrical cavity is suitable for receiving the sheet-like elements pushed by the punch.

Preferably said second portion of the forming surface has a first part, more preferably upper, with cylindrical development around said forming axis and a second part, more preferably lower and continuously connected to the first part, with a frusto-conical development around said forming axis (more preferably with tapering away from the first part), more preferably having a lateral surface inclined relative to the forming axis by less than 20°, or less than 15°. In this way, the forming of the filters starting from the sheet-like element is facilitated.

Preferably said forming surface is provided with ribs, more preferably having a development parallel to said forming axis. Preferably said first and second portions of the forming surface are provided with respective ribs configured to interlock with each other.

In this way, a pleating is imparted to the filter.

Preferably said one or more cleaning elements of a first cleaning device of said one or more cleaning devices comprise a first cylindrical brush having an axis. Preferably said axis of said first brush, during said reciprocating linear motion in said cleaning position, coincides with said forming axis to rub said first brush on said first portion of forming surface of said at least one forming device. The first brush, when moved by said reciprocating linear motion, is suitable for cleaning the cylindrical first portion of the forming surface.

Preferably said one or more cleaning elements of the first cleaning device comprise a second cylindrical brush having a respective axis parallel to said axis of the first brush, wherein a distance between the respective axes of said first and second brushes coincides with a distance between the respective forming axes of two adjacent forming devices. In this way, it is possible to clean two adjacent forming devices simultaneously.

Preferably said second brush has a bristle density lower than a bristle density of the first brush and a diameter greater than a diameter of said first brush. Preferably the diameter of the first brush is substantially equal to a diameter of an envelope of crests of said respective ribs of the first portion of the forming surface. In this way, the first brush is suitable for an effective cleaning of the crests of the ribs. Preferably, the diameter of the second brush is substantially equal to a diameter of an envelope of troughs of said respective ribs of the first portion of the forming surface. In this way, the second brush is suitable for an effective cleaning of the troughs while generating limited friction due to the reduced bristle density. The reduced friction allows for an appropriate sizing of the movement systems.

Preferably said one or more cleaning elements of a second cleaning device of said one or more cleaning devices comprise a ring brush having a respective axis. Preferably said axis of said ring brush, during said reciprocating linear motion in said cleaning position, coincides with said forming axis to rub said ring brush on said second portion of the forming surface of said at least one forming device. The ring brush, when moved by said reciprocating linear motion, is suitable for cleaning the substantially cylindrical second portion of the forming surface.

Preferably the inner diameter of the ring brush is substantially equal to a diameter of an envelope of troughs of said respective ribs of the second portion of the forming surface, more preferably of troughs of said respective ribs of the first part of the second portion, with a cylindrical development. In this way, the ring brush is suitable for an effective cleaning of the second portion of the forming surface.

Preferably each cleaning device comprises a fixed structure and a support body on which said one or more cleaning elements are mounted, more preferably rigidly, wherein the first and/or second movement system is configured to move said support body relative to said fixed structure. Preferably each cleaning device comprises an intermediate body on which the second movement system and said support body are mounted, wherein the first movement system is configured to move said intermediate body relative to said fixed structure and wherein the second movement system is configured to move said support body relative to said intermediate body. In this way the cleaning elements are moved in a simple and rational manner.

Preferably each cleaning device, more preferably each intermediate body, comprises, more preferably above, at least one centering element counter-shaped to a drive bar associated with said at least one forming device. In this way the correct alignment of the reciprocating linear motion with the forming axis is facilitated.

Preferably the machine comprises a fixed base and a drum supported by said base and rotating around a rotation axis.

Preferably said one or more forming devices are mounted on said drum with said forming axis parallel to said rotation axis.

Preferably said fixed structure is rigidly fixed to said base and said first movement system is structured to move said one or more cleaning elements, more preferably said intermediate body, along a radial direction with respect to said rotation axis.

Preferably each cleaning device is in an angular position with respect to said rotation axis in which said punch is located outside said through cavity. In this way both the cavity and the punch are easily accessible by the cleaning elements.

Preferably said first and second cleaning system are located on opposite sides with respect to said rotation axis.

Preferably the machine comprises a release device to release sheet-like elements on said one or more forming devices, wherein said first cleaning device is located immediately downstream of said release device and/or said second cleaning device is located upstream of said release device.

Preferably the method comprises, before moving said one or more cleaning elements from said disengagement position to said cleaning position, stopping a forming process of said filters on said machine.

Preferably the method comprises, before said imparting said reciprocating linear motion, stopping a rotation of said drum.

Preferably the method comprises, after said imparting said reciprocating linear motion:
rotating said drum around said rotation axis by at least one angular step between two adjacent forming devices;
imparting to said one or more cleaning members, in said cleaning position, said reciprocating linear motion to rub said one or more cleaning elements on said forming surface of at least one further forming device subsequent to said at least one forming device.

Preferably during said rotating said drum, said one or more cleaning elements are in said cleaning position and stationary.

Preferably in said cleaning position said respective axes of said first and second brush coincide respectively with the respective forming axes of two adjacent forming devices.

Preferably it is envisaged repeating, for all said cleaning devices, said operations of rotating said drum around said rotation axis by at least one angular step and imparting to said one or more cleaning members, in said cleaning position, said reciprocating linear motion.

Preferably said moving said one or more cleaning elements comprises simultaneously moving said one or more cleaning elements of both said first and second cleaning device.

Preferably, immediately after said moving said one or more cleaning elements from said disengagement position to said cleaning position and immediately before said imparting to said one or more cleaning elements said reciprocating linear motion, said one or more cleaning elements are located below said at least one forming device. In other words, the cleaning elements engage the forming device starting from the bottom, in order to take advantage of the spaces offered by the forming machine.

Preferably the method further comprises, after said imparting said reciprocating linear motion, moving said one or more cleaning elements of said at least one of said one or more cleaning devices from said cleaning position to said disengagement position and starting a forming process of said filters on said machine.

### BRIEF DESCRIPTION OF THE FIGURES

FIG. 1 is a schematic plan view of a production plant of infusion capsules;

FIG. 2 is a schematic and partial view of a machine in accordance with the present invention, in which a first cleaning device is visible;

FIG. 3 is a schematic and partial view of the first cleaning device of FIG. 1;

FIG. 4 is a schematic and partial view of a machine in accordance with the present invention, in which a second cleaning device is visible;

FIG. 5 is a schematic and partial view of the second cleaning device of FIG. 4.

### DETAILED DESCRIPTION OF SOME EMBODIMENTS OF THE INVENTION

The features and advantages of the present invention will be further clarified by the following detailed description of some embodiments, presented by way of example and not limitation of the present invention, with reference to the attached figures.

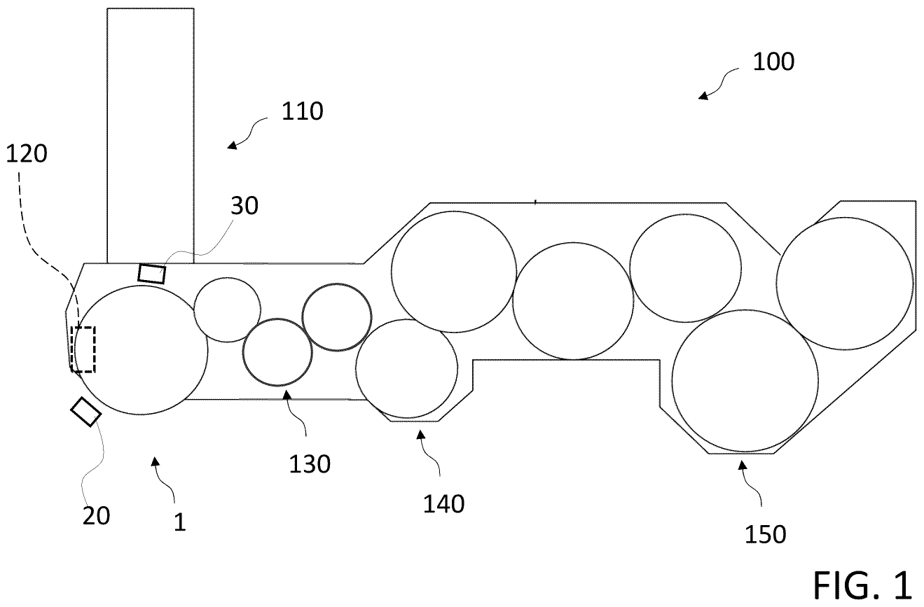

FIG. 1 shows by way of example a production plant 100 of capsules (not shown as for example of known type) for infusion beverages. Typically each capsule comprises a cup-shaped container (optionally equipped with a spacer element on the bottom), a filter housed in the cup-shaped container, an infusion preparation (e.g. a preparation based on coffee powder, sector to which reference will be made later without any limiting intent) and a lid sealing the cup-shaped container.

The plant 100 comprises the machine 1 for forming the filters for the infusion capsules according to the present invention.

Typically the plant 100 further comprises a feeding station 110 for supplying the cup-shaped containers to the machine 1, and, downstream of the machine 1, in addition to the rest, a machine for fixing 130 of the filters to the cup-shaped containers, a filling machine 140 for filling the containers with the powder preparation and a sealing machine 150 for sealing the lids to the containers.

The machines of the plant 100 additional to the machine 1 of the present invention, as well as their functioning, will not be further described or illustrated as for example of the known type, e.g. as described in the aforementioned WO2022029548A.

By way of example the plant 100, including the machine 1 for forming filters, comprises machines of the carousel type, which operate continuously with their respective semi-finished products (and their respective treatment devices) in continuous circular motion around a vertical axis. However the present invention is also applicable to machines for forming filters of the discontinuous type, where the filters are processed one batch at a time, and where the filters and the forming devices station during the forming process.

The machine 1 shown by way of example comprises a fixed base (not shown) and a drum 10 supported by the base and rotating around a rotation axis 11, typically vertical.

The machine comprises multiple forming devices 2 mounted on the drum 10, each forming device comprising a forming surface (not shown) having a substantially cylindrical configuration extending around a forming axis 5 parallel to the rotation axis 11.

Preferably each forming device 2 comprises a forming body 3 comprising a through cavity internally defining a first portion of the forming surface extending cylindrically around the forming axis.

Preferably each forming device 2 comprises a punch 4 externally defining a second portion of the forming surface having a first, upper part with a cylindrical development around the forming axis and a second, lower part seamlessly connected to the first part, with frusto-conical development around the forming axis and with tapering away from the first part. For example the lateral surface of the second frusto-conical part is inclined with respect to the forming axis 5 by approximately 10°. Preferably the first and second portions of the forming surface are provided with respective ribs with a development parallel to the forming axis 5 and configured to intermesh with each other, when the punch slidably engages the through cavity, moving along the forming axis 5 between an upper end, outside and above the cavity, and a lower end near a lower opening of the cavity.

The machine 1 comprises a release device 120, for example of the two-drum roller type.

The release device 120 is suitable for continuously releasing sheet-like elements to the forming devices 2. By way of example the sheet-like elements are composed of flat discs of a composite material (e.g. paper and polymeric material) suitable for forming a filter for infusion beverages.

The forming devices, the drive elements and the release device of the machine 1, as well as their functioning, along with any handling elements for the cup-shaped containers and the insertion of the filters into such containers, will not be further described or illustrated in detail, as they are of a known type (e.g. as described in WO2022029548A).

Preferably the machine comprises a first 20 and/or a second cleaning device 30, by way of example arranged in substantially opposite positions with respect to the rotation axis 11. Preferably the first cleaning device is located immediately downstream of the release device and/or the second cleaning device is located upstream of the release device.

Preferably each cleaning device 20, 30 comprises one or more cleaning elements 21, 22, 31.

In the illustrated example the first cleaning device 20 comprises a first cylindrical brush 21 and a second cylindrical brush 22, having respective axes mutually parallel and parallel to the forming axis 5, wherein the distance between the respective axes of the first and second brush coincides with the distance between the respective forming axes 5 of two adjacent forming devices 2. Preferably the diameter of the first brush 21 is substantially equal to the diameter of the envelope of the crests of the respective ribs of the first portion of the forming surface, and the diameter of the second brush 22 is substantially equal to the diameter of the envelope of the troughs of the respective ribs of the first portion of the forming surface. Preferably, the second brush 22 has a bristle density lower than the bristle density of the first brush 21.

By way of example the first cleaning device 20 also comprises an additional first brush 21′ and an additional second brush 22′, identical respectively to the first brush 21 and the second brush 22.

Preferably, the second cleaning device 30 comprises a ring brush 31 (e.g. also provided with bristles) having a respective axis parallel to the forming axis 5. Preferably the inner diameter of the ring brush is substantially equal to the diameter of the envelope of the troughs of the respective ribs of the second portion of the forming surface, more preferably of the first part of the second portion, with cylindrical development.

Preferably each cleaning device 20, 30 comprises a respective fixed structure 24, 34, rigidly fixed to the aforementioned base, a respective intermediate body 25, 35 movable with respect to the fixed structure, and a respective support body 26, 36, on which the respective cleaning elements are rigidly mounted.

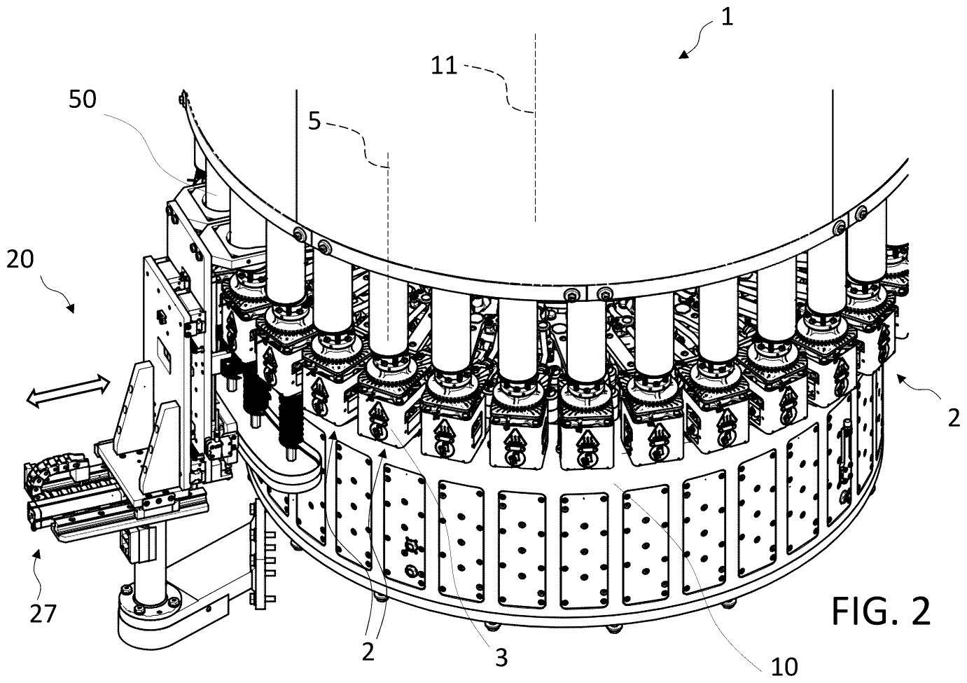

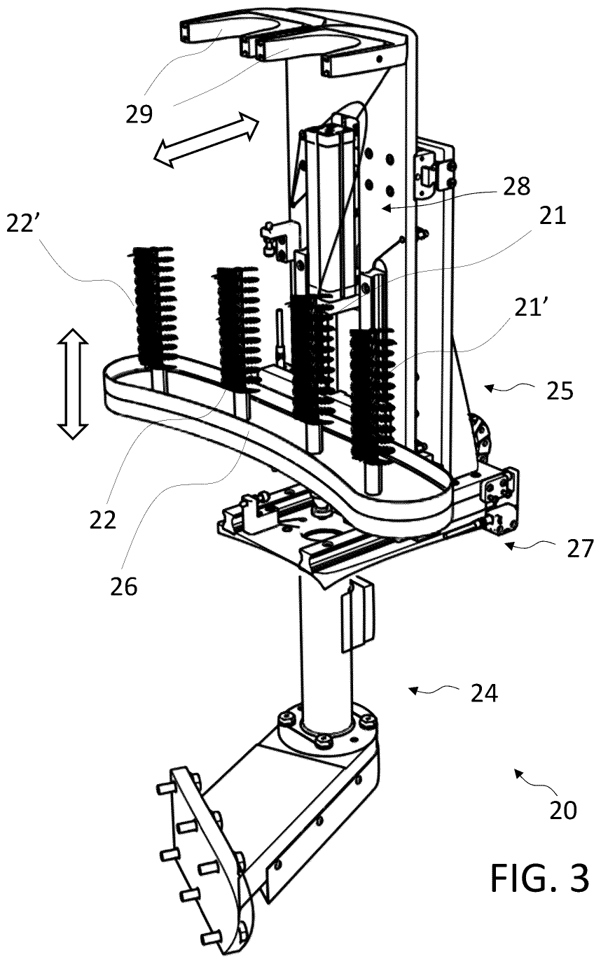

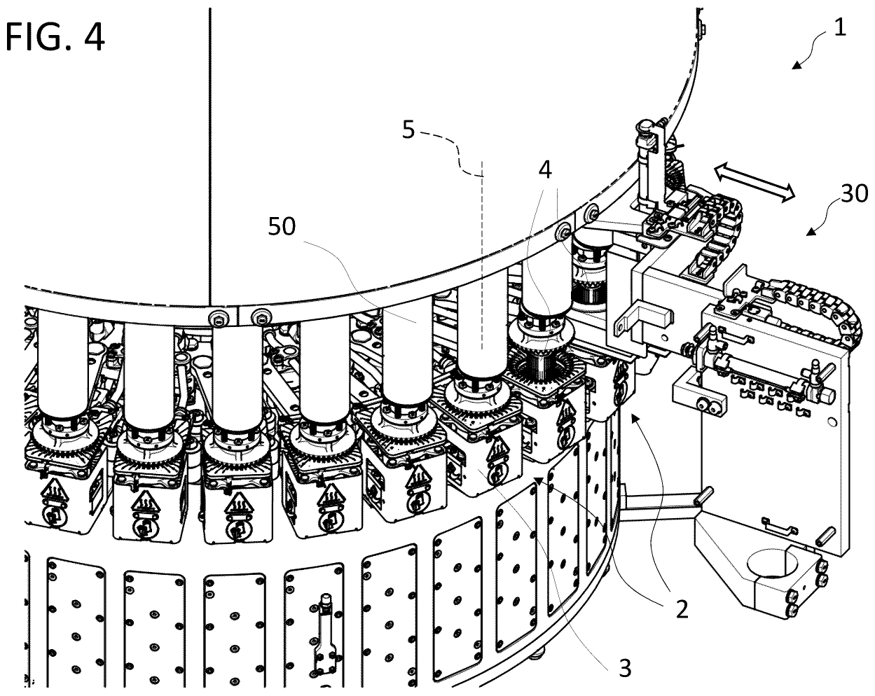

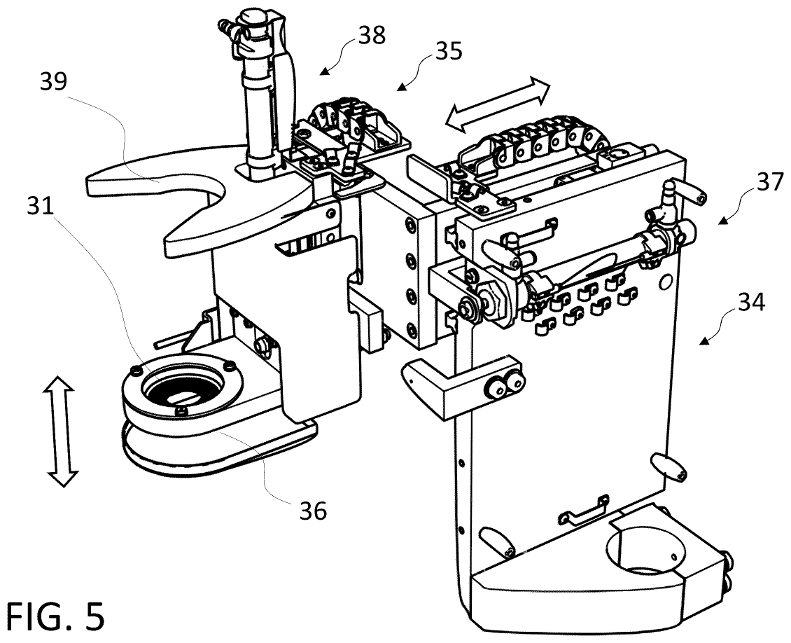

Preferably each cleaning device 20, 30 comprises a respective first movement system 27, 37 configured to move the intermediate body 25, 35 with respect to the fixed structure 24, 34 along a radial direction relative to the rotation axis 11 (as shown by the horizontal double arrow in the figures). The first movement system is configured to move the cleaning elements 21, 22, 31 between a disengaged position (shown in FIGS. 3 and 5), in which the cleaning elements do not mechanically interact with the forming devices 2, and a cleaning position (shown in FIGS. 2 and 4) in which the cleaning elements mechanically interact with at least one forming device 2.

Preferably each cleaning device 20, 30 comprises a respective second movement system 28, 38 mounted on the intermediate body 25, 35 and configured to move the support body 26, 36 relative to the intermediate body along a direction parallel to the forming axis 5.

The second movement system is configured to apply to the respective cleaning elements, when in the cleaning position, a reciprocating linear motion along the forming axis 5 to scrub the cleaning elements on the respective part of the forming surface of at least one forming device 2.

In particular, during the reciprocating linear motion in the cleaning position, the first brush 21 rubs on the first portion of the forming surface of a forming device 2, the second brush 22 rubs on the first portion of the forming surface of an additional forming device 2 adjacent to the aforementioned forming device 2 and the ring brush 31 rubs on the second portion of the forming surface of a respective forming device.

Exemplarily, the additional first brush 21′ and second brush 22′ rub on the first portion of the forming surface of respective additional forming devices 2.

From the above it is understood that “cleaning position” refers, rather than to a single point position, to the set of positions assumed by the cleaning elements along the reciprocating linear motion.

The movement systems exemplarily comprise actuators (e.g. electric, pneumatic, hydraulic, etc.), preferably linear, and appropriate guides and/or telescopic systems.

Preferably each intermediate body comprises above at least one centering member 29, 39 counter-shaped to a drive bar 50 (e.g. cylindrical) associated with each forming device.

The cleaning method of the machine 1 is typically performed outside production by stopping the filter forming process on the machine.

During the normal operation of the machine 1, the cleaning elements 21, 22, 31 are located in the disengaged position.

Once the rotation of the drum 10 has stopped, it is envisaged moving, via the first movement system, the respective cleaning elements of at least one (preferably both and simultaneously) between the first and second cleaning devices from the disengaged position to the cleaning position.

The cleaning elements are thus located below the respective forming device and in axis with the latter. Preferably each cleaning device 20, 30 is located at an angular position relative to the rotation axis 11 in which the punch 4 is located outside the through cavity.

At this point it is envisaged, through the second movement system, imparting to the cleaning elements, in the cleaning position, the aforementioned alternating rectilinear motion to rub the cleaning elements on the respective part of the forming surface of the respective forming device.

In the example illustrated above, the brush 21 cleans the even forming bodies and the brush 22 cleans the odd forming bodies. If present, the brushes 21′ and 22′ clean the forming bodies of further adjacent odd and even devices respectively.

Once cleaning is complete, it is envisaged rotating the drum 10 around the rotation axis by at least one angular step between two adjacent forming devices, keeping the cleaning elements in the cleaning position and stationary. In this way the brushes are located at further cleaning devices.

With the drum in the new position it is envisaged imparting once again the alternating rectilinear motion to the cleaning elements in the cleaning position in order to rub them on the respective part of the forming surface of the respective further forming devices.

The above procedure is repeated for a complete revolution of the drum in order to clean all the forming devices.

If brushes 21′ and 22′ are present, it is possible to rotate the drum by two angular steps: in this case once a complete revolution has been completed the drum is rotated by a single step to reverse the parity of the cleaning devices subject to cleaning, and subsequently the procedure is resumed for another complete revolution.

Once the cleaning procedure is completed, the cleaning parts are returned to the disengagement position to start the filter forming process on machine 1.

1. A machine for forming filters for infusion capsules, the machine comprising:
one or more forming devices, each forming device comprising a forming surface for the forming of said filters, said forming surface having a substantially cylindrical configuration developing around a forming axis; and
one or more cleaning devices, each cleaning device comprising:
one or more cleaning elements;
a first movement system configured to move said one or more cleaning elements between a disengagement position, wherein said one or more cleaning elements do not mechanically interact with said one or more forming devices, and a cleaning position wherein said one or more cleaning elements mechanically interact with at least one forming device of said one or more forming devices; and
a second movement system configured to impart to said one or more cleaning elements, when in said cleaning position, a reciprocating linear motion along said forming axis to rub said one or more cleaning elements on at least a part of said forming surface of said at least one forming device.

2. The machine according to claim 1, wherein each forming device comprises a forming body including a through cavity internally defining a first portion of said forming surface, said first portion having a cylindrical development around said forming axis, wherein said one or more cleaning elements of a first cleaning device of said one or more cleaning devices comprise a first cylindrical brush having an axis coinciding, during said reciprocating linear motion in said cleaning position, with said forming axis to rub said first brush on said first portion of forming surface of said at least one forming device.

3. The machine according to claim 2, wherein said one or more cleaning elements of the first cleaning device comprise a second cylindrical brush having a respective axis parallel to said axis of the first brush, wherein a distance between the respective axes of said first and second brush coincides with a distance between respective forming axes of two adjacent forming devices, and wherein said second brush has a bristle density lower than a bristle density of the first brush and a diameter greater than a diameter of said first brush.

4. The machine according to claim 1, wherein each forming device comprises a punch externally defining a second portion of said forming surface, said second portion having a first part with a cylindrical development around said forming axis and a second part with a frusto-conical development around said forming axis, and wherein said one or more cleaning elements of a second cleaning device of said one or more cleaning devices comprise a ring brush having a respective axis coinciding, during said reciprocating linear motion in said cleaning position, with said forming axis to rub said ring brush on said second portion of forming surface of said at least one forming device.

5. The machine according to claim 1, wherein each cleaning device comprises a respective fixed structure and a respective support body on which said one or more cleaning elements are mounted, wherein the first and/or second movement system is configured to move said support body relative to said fixed structure.

6. The machine according to claim 1, comprising a fixed base and a drum supported by said base and rotating around a rotation axis, wherein said one or more forming devices are mounted on said drum with said forming axis parallel to said rotation axis.

7. The machine according to claim 5, wherein said fixed structure is rigidly fixed to said base and wherein said first movement system is structured to move said one or more cleaning elements along a radial direction with respect to said rotation axis.

8. The machine according to claim 2, wherein each cleaning device is located in an angular position relative to said rotation axis in which said punch is out of said through cavity.

9. The machine according to claim 6, wherein said first and second cleaning device are located on opposite sides with respect to said rotation axis.

10. The machine according to claim 2, comprising a release device for releasing sheet-like elements onto said one or more forming devices, wherein said first cleaning device is located immediately downstream of said release device and/or said second cleaning device is located upstream of said release device.

11. A method for cleaning a machine according to claim 1, the method comprising:
moving said one or more cleaning elements of at least one of said one or more cleaning devices from said disengagement position to said cleaning position;
imparting to said one or more cleaning elements, in said cleaning position, said reciprocating linear motion to rub said one or more cleaning elements on at least a part of said forming surface of said at least one forming device.

12. The method according to claim 11, wherein said machine further comprises a fixed base and a drum supported by said base and rotating around a rotation axis, wherein said one or more forming devices are mounted on said drum with said forming axis parallel to said rotation axis, the method further comprising, after said imparting said reciprocating linear motion:
rotating said drum around said rotation axis by at least one angular step between two adjacent forming devices; and
imparting to said one or more cleaning elements, in said cleaning position, said reciprocating linear motion to rub said one or more cleaning elements on at least a part of said forming surface of at least one further forming device subsequent to said at least one forming device.

13. The method according to claim 12, wherein a fixed base and a drum supported by said base and rotating around a rotation axis, wherein said one or more forming devices are mounted on said drum with said forming axis parallel to said rotation axis, wherein in said cleaning position said respective axes of said first and second brush coincide respectively with the respective forming axes of two adjacent forming devices.

14. The method according to claim 11, wherein each forming device comprises a forming body including a through cavity internally defining a first portion of said forming surface, said first portion having a cylindrical development around said forming axis, wherein said one or more cleaning elements of a first cleaning device of said one or more cleaning devices comprise a first cylindrical brush having an axis coinciding, during said reciprocating linear motion in said cleaning position, with said forming axis to rub said first brush on said first portion of forming surface of said at least one forming device, wherein said moving said one or more cleaning elements includes moving simultaneously said one or more cleaning elements of both said first and second cleaning device.

15. The method as according to claim 11, wherein, immediately after said moving said one or more cleaning elements from said disengagement position to said cleaning position and immediately before said imparting to said one or more cleaning elements said reciprocating linear motion, said one or more cleaning elements are located below said at least one forming device.
